(19) United States
(12) Patent Application Publication
(10) Pub. No.: US 2007/0169316 A1
(43) Pub. Date: Jul. 26, 2007

(54) Hinge with a positioning and limiting assembly

(75) Inventors: Sheng-Nan Lu, Shulin City (TW); Hsiang-Chi Chien, Shulin City (TW); Chia-Hsiang Chen, Shulin City (TW)

Correspondence Address: CHARLES E. BAXLEY, ESQ., 90 JOHN STREET, THIRD FLOOR, NEW YORK, NY, 10038, US

(73) Assignee: Shin Zu Shing Co., Ltd.

(21) Appl. No.: 11/336,750

(22) Filed: Jan. 20, 2006

(51) Int. Cl. E05D 3/10

(52) U.S. Cl. 16/367

(57) ABSTRACT

A hinge has a first bracket, a first pivot pin, a second pivot pin, a second bracket and a positioning and limiting assembly. The first pivot pin is on the first bracket. The second pivot pin is mounted rotatably on the first pivot pin and has a mounting recess. The second bracket is mounted pivotally on the second pivot pin. The positioning and limiting assembly is mounted in the mounting recess in the second pivot pin and has a seat, a positioning disk and limiting disk. The seat is mounted in the mounting recess. The positioning disk is mounted to the first pivot pin and detachably engage the seat. The limiting disk is mounted to the first pivot pin and selectively abuts seat. The positioning and limiting assembly in the mounting recess makes the hinge compact and easily apply to portable devices such as cell phones and digital cameras.

### BACKGROUND OF THE INVENTION

1. Field of the Invention

The present invention relates to a hinge, and more particularly to a hinge that has a positioning and limiting assembly and is compact.

2. Description of Related Art

Many appliances and electronic devices have a body and a cover, for example notebook computers. A hinge is usually mounted between the body and the cover and pivots to open or close the cover. Some improved hinges used in digital cameras allow a cover with a display to be able to pivot and rotate relative to a body. The improved hinges also have a positioning function to keep the cover at some specific positions and a limiting function to keep the cover from over pivoting. However, these improved hinges comprise numerous elements and make the sizes of hinges too large to be mounted to a portable electronic device.

To overcome the shortcomings, the present invention provides a hinge with a positioning and limiting assembly to mitigate or obviate the aforementioned problems.

### SUMMARY OF THE INVENTION

The main objective of the invention is to provide a hinge that has a positioning and limiting assembly and is compact.

A hinge in accordance with the present invention comprises a first bracket, a first pivot pin, a second pivot pin, a second bracket and a positioning and limiting assembly.

The first pivot pin is on the first bracket.

The second pivot pin is mounted rotatably on the first pivot pin and has a mounting recess.

The second bracket is mounted pivotally on the second pivot pin.

The positioning and limiting assembly is mounted in the mounting recess in the second pivot pin and has a seat, a positioning disk and limiting disk. The seat is mounted in the mounting recess. The positioning disk is mounted to the first pivot pin and detachably engage the seat. The limiting disk is mounted to the first pivot pin and selectively abuts seat.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hinge in accordance with the present invention;

FIG. 2 is another perspective view of the hinge in FIG. 1;

FIG. 3 is an exploded perspective view of the hinge in FIG. 1;

FIG. 4 is an operational side view of the hinge in FIG. 1;

FIG. 5 is a front view of the hinge in FIG. 1;

FIG. 6 is an operational front view of the hinge in FIG. 5;

FIG. 7 is top view of the hinge in FIG. 1;

FIG. 8 is an operational front view of the hinge in FIG. 7;

FIG. 9 is a perspective view of a second embodiment of a hinge in accordance with the present invention;

FIG. 10 is an exploded perspective view of the hinge in FIG. 9;

FIG. 11 is a side view in partial section of the hinge in FIG. 10;

FIG. 12 is an operational side view in partial section of the hinge in FIG. 11;

FIG. 13 is a perspective view of a third embodiment of a hinge in accordance with the present invention; and

FIG. 14 is an exploded perspective view of the hinge in FIG. 13.

### DETAILED DESCRIPTION OF THE PREFERRED EMBODIMENT

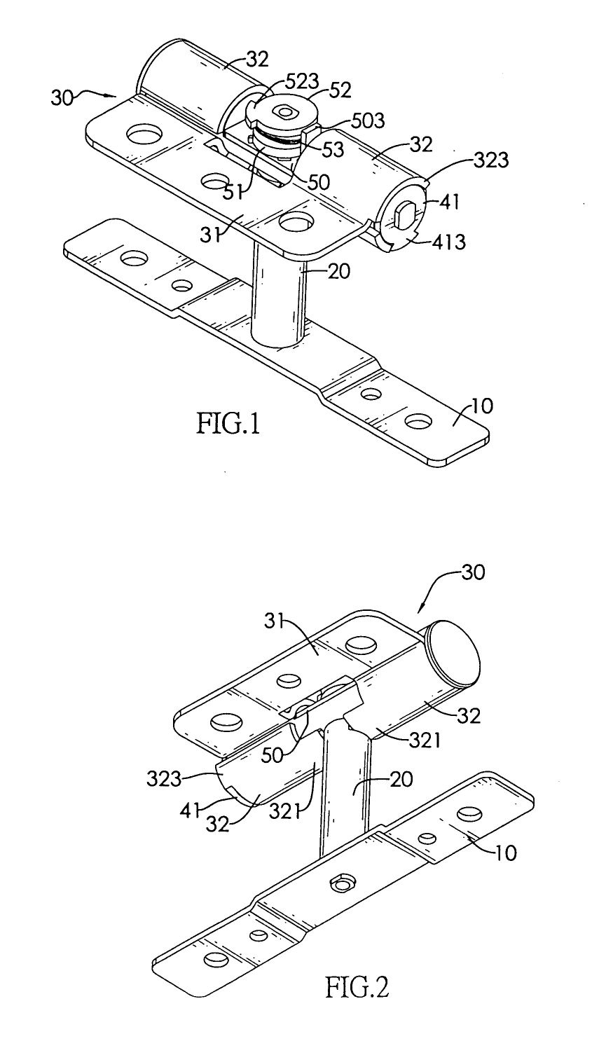

With reference to FIGS. 1 to 3, a hinge in accordance with the present invention is applied with a device such as a digital camera or a cell phone. The device has a body and a cover. The body and cover are pivotally connected to each other through the hinge.

A first embodiment of the hinge in accordance with the present invention comprises a first bracket (10), a first pivot pin (20), a second pivot pin (40), a second bracket (30) and a positioning and limiting assembly.

The first bracket (10) is mounted to the body.

The first pivot pin (20) is mounted on the first bracket (10) and has a bottom end, a top end, two opposite limiting notches (21), a post and an annular shoulder (23). The bottom end is mounted to the first bracket (10). The limiting notches (21) defined radially into the first pivot pin (20) at the top end. The post extends up from the top end and has a mounting segment (22) with a non-circular cross section. The annular shoulder (23) defined on the top end around the post.

The second pivot pin (40) is mounted rotatably on the first pivot pin (20), is held rotatably by the shoulder (23) and has two ends, an annular outer flange (401), a mounting protrusion (402), a mounting recess (403), a pivot hole (404) and a limiting disk (41). The annular outer flange (401) extends radially on one end of the second pivot pin (40). The mounting protrusion (402) extends out from the other end of the second pivot pin (40). The mounting recess (403) is defined radially in the second pivot pin (40). The pivot hole (404) is defined through the second pivot pin (40), communicates with the mounting recess (403) and allows the post to rotatably extend through the pivot hole (404). The limiting disk (41) is mounted securely around the mounting protrusion (402) and has a limiting tab (413) extending radially out from limiting disk (41).

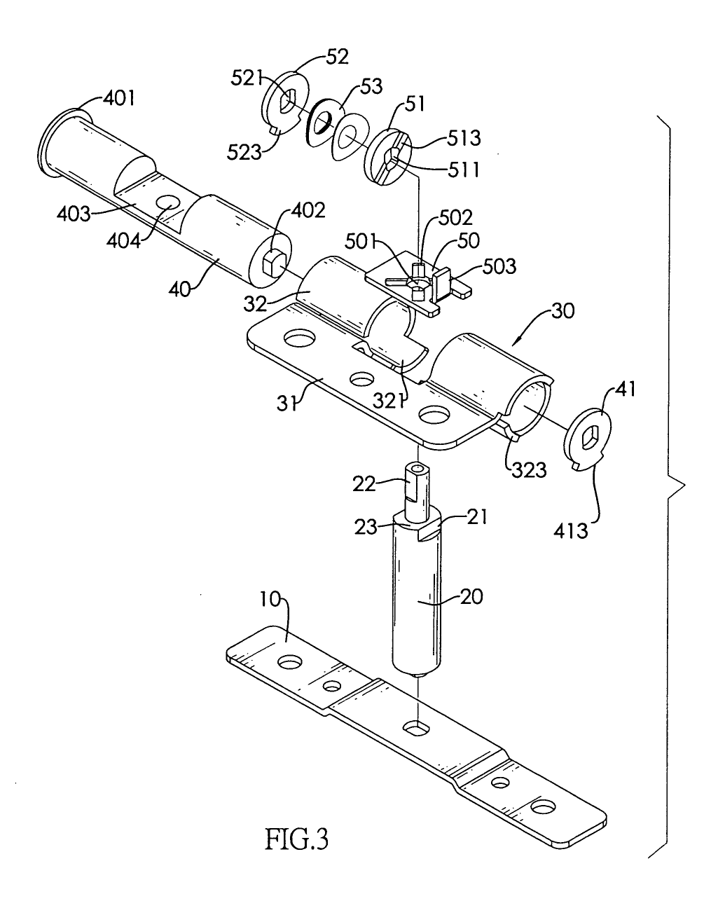

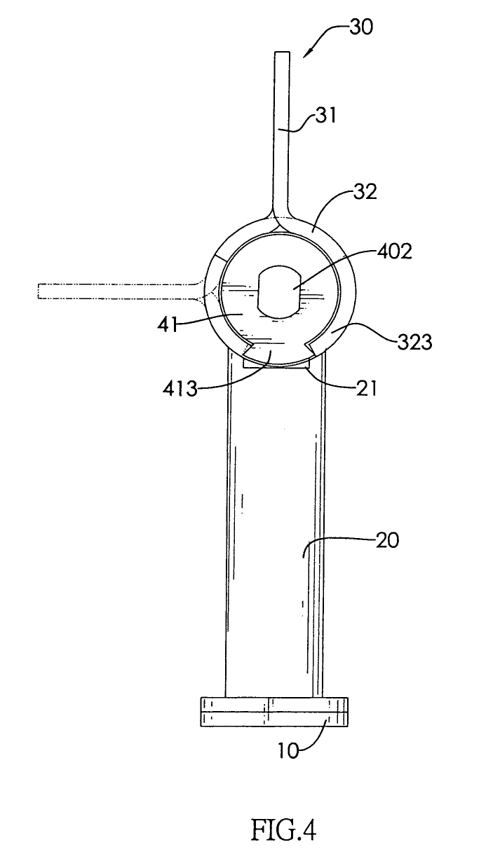

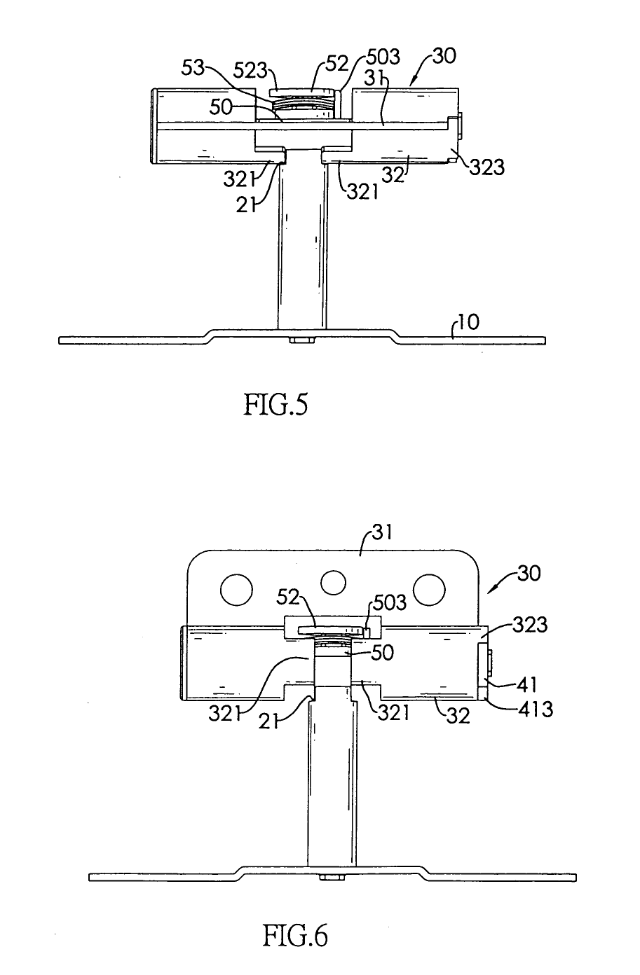

With reference to FIGS. 3, 5 and 6, the second bracket (30) is mounted pivotally to the second pivot pin (40), is mounted to the cover and has a mount (31), two sleeves (32) and a pivot-limiting protrusion (323). The mount (31) is mounted to the cover. The sleeves (32) are formed on the mount (31) at an interval through which the post on the first pivot pin (20) extends and are mounted rotatably around the second pivot pin (40). One of the sleeves (32) abuts the annular outer flange (401) on the second pivot pin (40). Each sleeve (32) has an outside open end, an inside open end and a rotation-limiting tab (321). The rotation-limiting tab (321) extends from the inside open end and engages with a corresponding one of the notches (21) in the first pivot pin (20) when the second bracket (30) pivots to a specific position along the second pivot pin (40). The engagement of the rotation-limiting tabs (321) and the limiting-notches (21) holds and keeps the second pivot pin (40) and second bracket (30) from rotating relative to the first pivot pin (20), as shown in FIG. 4.

With reference to FIG. 4, the pivot-limiting protrusion (323) is formed on the outside end of one of the sleeves (32) and has two ends and a gap. The gap is defined between the ends of the pivot-limiting protrusion (323), is larger than and receives the limiting tab (413) on the limiting disk (41). The abutment of one end of the pivot-limiting protrusion (323) and the limiting tab (413) on the limiting disk (41) prevents the second bracket (30) from further pivoting.

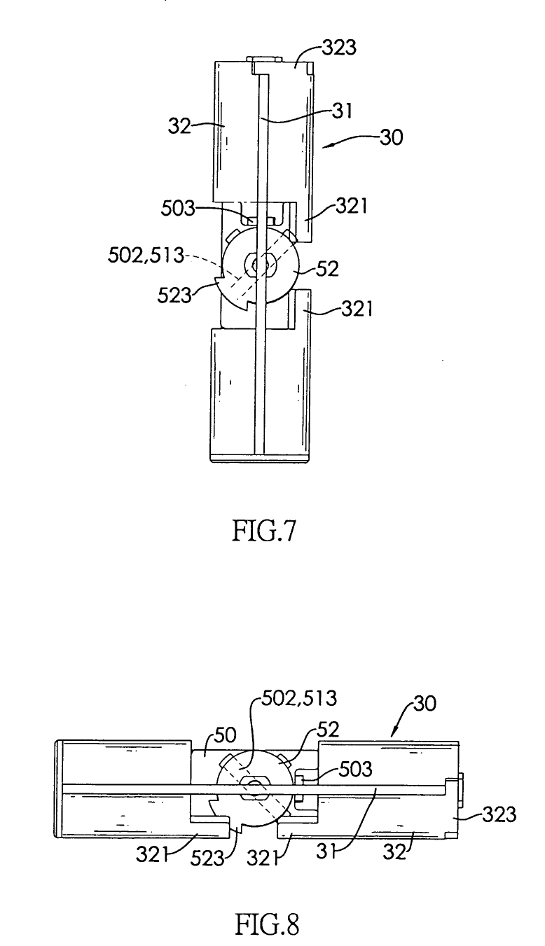

With reference to FIGS. 3, 7 and 8, the positioning and limiting assembly is mounted in the mounting recess (403) in the second pivot pin (40) and has a seat (50), a positioning disk (5 1), a limiting disk (52) and at least one annular leaf spring (53).

The seat (50) is mounted securely in the mounting recess (403), is mounted rotatably around the post on the first pivot pin (20) and has a top, a pivot hole (501), multiple keyways (502) and a limiting tab (503). The pivot hole (501) is defined through the seat (50) and allows the post on the first pivot pin (20) to rotatably extend through the pivot hole (501). The keyways (502) are defined in the top and are arranged around the pivot hole (501). The limiting tab (503) extends from the top.

The positioning disk (51) is mounted slidably around the mounting segment (22) of the post on the first pivot pin (20), rotatably and detachably engages with the seat (50) and has a bottom, a mounting hole (511) and multiple keys (513). The mounting hole (511) is defined through the positioning disk (51), allows the mounting segment (22) of the post on the first pivot pin (20) to slidably extend through the mounting hole (511) and has a non-circular cross section corresponding to the non-circular cross section of the mounting segment (22). The keys (513) protrude from the bottom of the positioning disk (5 1), are arranged around the mounting hole (511) and detachably engage with the keyways (502) in the seat (50). The second pivot pin (40) and the second bracket (30) are held at specific positions when the keys (513) engage the keyways (502). The engagement of the keys (513) and keyways (502) prevents the second pivot pin (40) and second bracket (30) from rotating arbitrarily. Rotating the second bracket (30) and the second pivot pin (40) with an appropriate force causes the keys (513) to disengage from the keys (502) so that the second pivot pin (40) can rotate easily.

The limiting disk (52) is mounted securely around the mounting segment (22) of the post on the first pivot pin (20) and has a mounting hole (521) and a limiting tab (523). The mounting hole (521) is defined through the limiting disk (52), allows the mounting segment (22) of the first pivot pin (20) to extend through the mounting hole (521) and has a non-circular cross section. The limiting tab (523) radially extends out from the limiting disk (52), corresponds to the limiting tab (503) on the seat (50) and abuts the limiting tab (503) when the second pivot pin (40) turns left or right to the end. The abutment of the limiting tabs (523, 503) prevents the second pivot pin (40) from over rotating.

The at least one annular leaf spring (53) is mounted around the mounting segment (22) of the post on the first pivot pin (20) between the limiting disk (52) and the positioning disk (51) and presses against the positioning disk (51) to always contact the top of the seat (50).

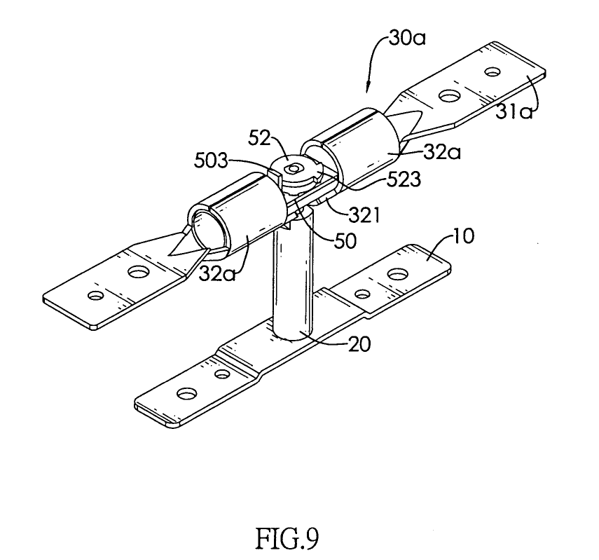

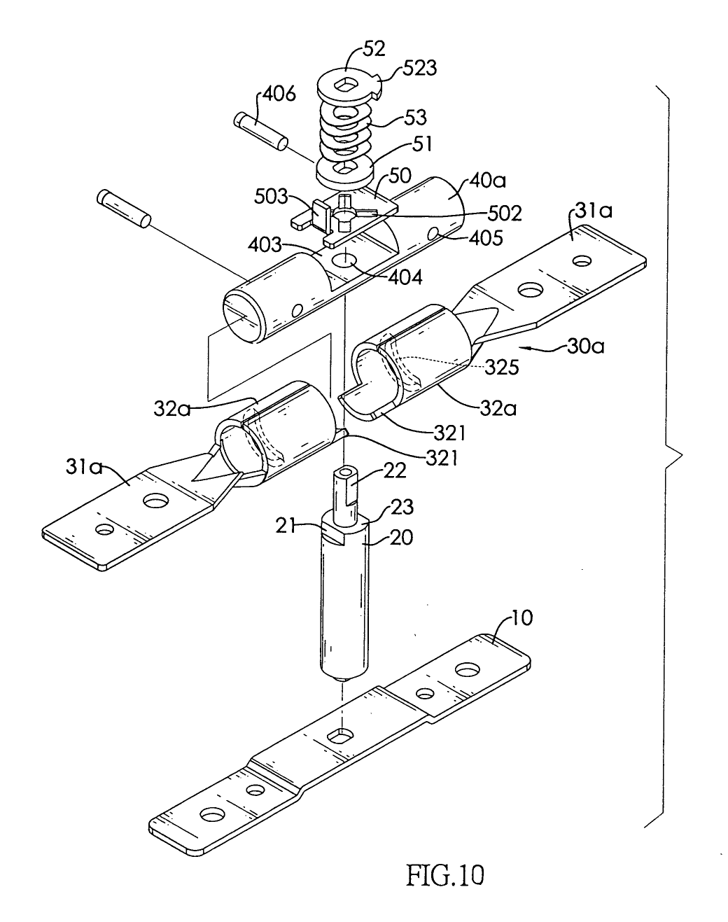

With reference to FIGS. 9 and 10, a second embodiment of the hinge in accordance with the present invention is similar to the first embodiment except that the second pivot pin (40a) and the second bracket (30).

The second pivot pin (40a) has a mounting recess (403), a pivot hole (404), two pin holes (405) and two limiting pins (406). The mounting recess (403) and the pivot hole (404) are the same as those in the first embodiment. The pin holes (405) are defined transversely in the second pivot pin (40a). The limiting pins (406) are mounted respectively in the pin holes (405) and each limiting pin (406) has an outside end extending out of a corresponding pin hole (405).

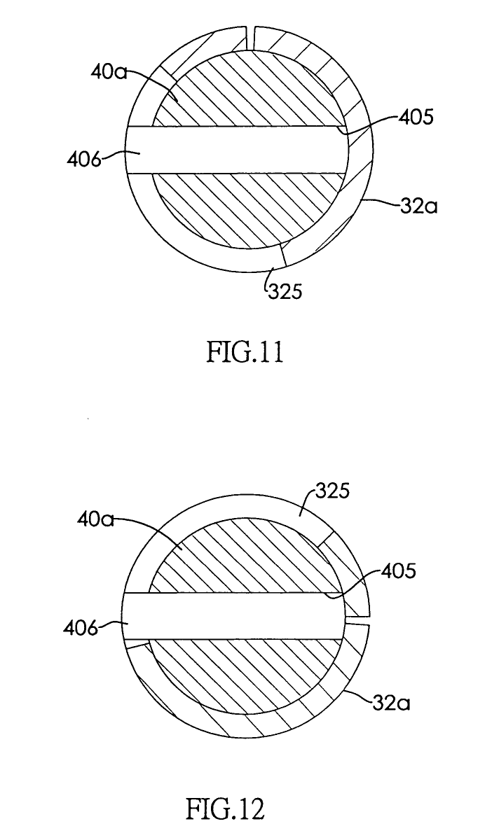

The second bracket (30a) is composed of two supports corresponding to the limiting pins (406) and each support has a sleeve (32a) and a mount (31a). The sleeve (32a) is mounted rotatably around the second pivot pin (40a) and has an inside open end, an outside open end, a rotation-limiting tab (321) and a slot (325). The rotation-limiting tab (321) is the same as that in the first embodiment. The slot (325) is defined transversely through the sleeve (32a), receives the outside end of a corresponding limiting pin (406) and has an inner edge. With reference to FIGS. 11 and 12, the limiting pin (406) abuts the inner edge of the slot (325) to keep the second pivot pin (40a) from further rotating when the second bracket (30a) rotates clockwise or counterclockwise to the end. The mount (31a) extends from the outside open end of the sleeve (32a) and is mounted to the cover.

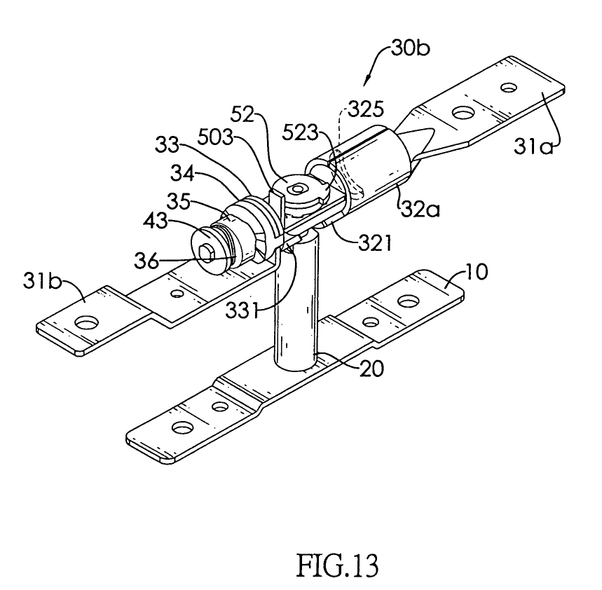

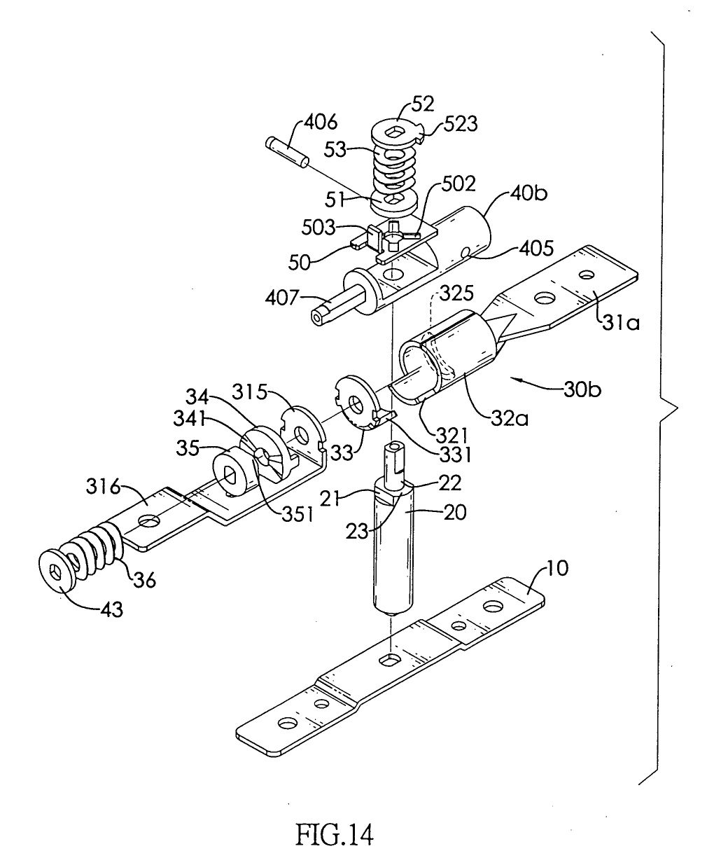

With reference to FIGS. 13 and 14, a third embodiment of the hinge in accordance with the present invention is similar to the second embodiment and has the second pivot pin (40b) and the second bracket (30b) to be modified.

The second pivot pin (40b) has a mounting recess (403), a pivot hole (404), a pin hole (405), a mounting rod (407) and a limiting pin (406). The mounting recess (403) and the pivot hole (404) are the same as those in the first embodiment. The pin hole (405) is defined transversely in the second pivot pin (40b). The mounting rod (407) extends from one end of the second pivot pin (40b) and has a non-circular cross section. The limiting pin (406) is mounted in the pin holes (405) and has an outside end extending out of the pin hole (405).

The second bracket (30b) has a pivot-positioning assembly and a support.

The pivot-positioning assembly is mounted to the mounting rod (407) on the second pivot pin (40) and has a rotation-limiting disk (33), a mounting bracket (31b), a stationary disk (34), a slidable disk (35), at least one leaf spring (36) and a fastener (43). The rotation-limiting disk (33) is mounted rotatably around the mounting rod (407) on the second pivot pin (40b) and has a rotation-limiting tab (331) extending from the rotation-limiting disk (33) and corresponding to a corresponding one of the limiting notches (21) in the first pivot pin (20). The mounting bracket (31b) is mounted rotatably on the mounting rod (407) on the second pivot pin (40b), is mounted to the cover and has an inside end and a connecting tab (315). The connecting tab (315) perpendicularly extends from the inside end of the mounting bracket (31b) and has a pivot hole through which the mounting rod (407) rotatably extends. The stationary disk (34) is mounted rotatably around the mounting rod (407), is mounted securely to the connecting tab (315) and the rotation-limiting disk (33) of the pivot-positioning assembly and has multiple ridges (341) formed on the stationary disk (34) at intervals. The slidable disk (35) is mounted slidably around the mounting rod (407), rotatably and detachably engages with the stationary disk (34) and has multiple ridges (351) formed on the slidable disk (35) at intervals and detachably engages respectively in the intervals between the ridges (341) on the stationary disk (34). The engagement of the stationary disk (34) and the slidable disk (35) holds the mounting bracket (31b) at different positions.

The support is the same as that in the second embodiment, corresponds to the limiting pin (406) and has a sleeve (32a) and a mount (31a). The rotation-limiting tab (321) on the sleeve (32a) engages a corresponding notch (21) in the first pivot pin (20) when the rotation-limiting tab (331) of the rotation-limiting disk (33) of the pivot-positioning assembly engages the other notch (21).

The positioning and limiting assembly can hold the second bracket (30, 30a, 30b) and the second pivot pin (40, 40a, 40b) at specific rotational positions and prevent them from over rotating which breaks transmission wires between the cover and the body. Furthermore, the positioning and limiting assembly completely mounted in the mounting recess (403) in the second pivot pin (40, 40a, 40b) makes the hinge compact and easily apply to portable devices such as cell phones and digital cameras.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a first bracket;
a first pivot pin mounted on the first bracket and having a bottom end mounted to the first bracket and a top end;
a second pivot pin mounted rotatably on the first pivot pin and having
two ends;
a mounting recess defined in the second pivot pin; and
a pivot hole defined through the second pivot pin, communicating with the mounting recess and through which the first pivot pin rotatably extends;
a second bracket mounted pivotally to the second pivot pin; and
a positioning and limiting assembly mounted in the mounting recess in the second pivot pin and having
a seat mounted securely in the mounting recess, mounted rotatably around the first pivot pin and having a top, a pivot hole defined through the seat and through which the first pivot pin rotatably extends, multiple keyways defined in the top and arranged around the pivot hole and a limiting tab extending from the top;
a positioning disk mounted slidably around the first pivot pin, rotatably and detachably engaging the seat and having
a mounting hole defined through the positioning disk and through which the first pivot pin slidably extends; and
multiple keys protruding from the bottom of the positioning disk, arranged around the mounting hole and detachably engaging the keyways in the seat; and
a limiting disk mounted securely around the first pivot pin and having a limiting tab radially extending out from the limiting disk, corresponding to the limiting tab on the seat and abutting the limiting tab when the second pivot pin turns to an end.

2. The hinge as claimed in claim 1, wherein the positioning and limiting assembly further has at least one annular leaf spring mounted around the first pivot pin between the limiting disk and the positioning disk and pressing against the positioning disk to always contact the top of the seat.

3. The hinge as claimed in claim 2, wherein:
the first pivot pin further has a post extending up from the top end and having a mounting segment with a non-circular cross section and a shoulder defined on the top end around the post and rotatably holding the second pivot pin; and
the positioning disk is mounted slidably around the mounting segment and the mounting hole of the positioning disk has a non-circular cross section corresponding to the non-circular cross section the mounting segment of the post on the first pivot pin.

4. The hinge as claimed in claim 1, wherein:
the first pivot pin further has two opposite notches defined in the first pivot pin; and
the second bracket has a mount and two sleeves formed on the mount at an interval through which the first pivot pin extends and mounted rotatably around the second pivot pin and each sleeve has an outside open end, an inside open end and a rotation-limiting tab extending from the inside open end and engaging a corresponding one of the notches in the first pivot pin when the second bracket pivots to a specific position.

5. The hinge as claimed in claim 4, wherein:
the second pivot pin further has a limiting disk mounted securely on one end of the second pivot pin and having a limiting tab extending radially out from the limiting disk; and
a pivot-limiting protrusion formed on the outside end of one of the sleeves and having two ends and a gap defined between the ends and larger than and receiving the limiting tab on the limiting disk on the end of the second pivot pin.
